(19) United States
(12) Patent Application Publication
(10) Pub. No.: US 2023/0283015 A1
(43) Pub. Date: Sep. 7, 2023

(54) Plug Connector Assembly and Battery Assembly

(71) Applicant: Rosenberger Hochfrequenztechnik GmbH & Co. KG, Fridolfing (DE)

(72) Inventors: Tobias Egger, Fridolfing (DE); Ulrich Hasenoehrl, Ainring (DE)

(21) Appl. No.: 18/116,471

(22) Filed: Mar. 2, 2023

(30) Foreign Application Priority Data
Mar. 3, 2022 (EP) 22 159 933.5

(51) Int. Cl. H01R 13/631

(52) U.S. Cl. CPC H01R 13/6315

(57) ABSTRACT

A plug connector assembly having an electrical plug connector, which is electrically and mechanically connectable along a first degree of freedom of translation (x) to a corresponding mating plug connector. The plug connector assembly has a housing component and at least one elastic element, which connects the plug connector indirectly or directly to the housing component. The elastic element allows a movement of the plug connector relative to the housing component along a first degree of freedom of translation (x) and/or along a second degree of freedom of translation (y) and/or along a third degree of freedom of translation (z). The plug connector assembly has at least one floating bearing assembly for delimiting the movability of the plug connector along at least one of the degrees of freedom of translation (x, y, z), the at least one floating bearing assembly having a bearing recess and a bearing elevation.

The invention relates to a plug connector assembly having an electrical plug connector, which is electrically and mechanically connectable along a first degree of freedom of translation to a corresponding mating plug connector, a housing component and at least one elastic element, according to the preamble of claim 1.

The invention additionally relates to a battery assembly having a plug connector assembly.

Various electrical plug connectors are known from the field of electrical engineering. Electrical plug connectors are known to transmit electrical supply signals and/or data signals to corresponding mating plug connectors. A plug connector or mating plug connector can be a plug, a printed circuit board plug connector, a male panel plug connector, a socket, a coupling or an adapter. The designation “plug connector” or “mating plug connector” used in the context of the invention is representative of all variants.

It is sometimes necessary to fasten a plug connector “floatingly” on a surrounding component part, such as a housing component, so that the plug connector and thus also the plugged plug connection can perform a compensation movement in one degree of freedom or in a plurality of degrees of freedom. A floating bearing is advantageous in particular when plug connectors and/or mating plug connectors are rigidly connected to an electrical device which is movable to a certain degree during operation since the movement transferred from the electrical device (for example a battery) to the plug connector may cause damage to the plug connection and/or may result in a loss of contact. A floatingly mounted plug connector makes it possible to follow the movements of the electrical device within defined limits, which may reduce the mechanical loading.

For example, vehicle batteries of electric vehicles, in particular of electrically operated two-wheelers (for example E-scooters and E-bikes), are often mounted in a battery-receiving container. The vehicle battery in this case is typically fastened in the battery-receiving container, however, on account of component part tolerances for example, is sometimes still movable to a certain extent along at least one degree of freedom of translation or rotation, and therefore, in particular if the ground surface is uneven and there are vibrations, the arrangement of the vehicle battery inside the battery-receiving container may change (that is to say the position and/or orientation may change). Since the vehicle battery is generally connected to a plug connector in the battery-receiving container via a plug connector (hereinafter the “mating plug connector”) mounted on the battery housing, the movement of the vehicle battery is transferred directly to said plug connection, and therefore high mechanical forces can sometimes act on the plug connection during driving operation.

Ways of realizing a floating fastening of a plug connector are already known in principle in the prior art. Reference is made by way of example to DE 20 2010 003 651 U1, which describes a plug connector with a floating bearing.

In the known solutions the movability of the plug connector is generally realized via a mounting of the plug connector in a number of elastic elements corresponding to the number of degrees of freedom of compensation. The technical effort and thus also the costs for providing a plug connector assembly having a floatingly mounted plug connector are relatively high in the known solutions.

There may additionally be a conflict of objectives if the plug connector, in the unplugged basic state, is to be disposed in a clearly defined, spatial starting position, for example in order to be able to be plugged “blindly” together with the mating plug connector or in order to simplify such a plugging together. This requirement in the known solutions is usually in conflict with the floating fastening.

In view of the known prior art, the object of the present invention is to provide a plug connector assembly which makes it possible to realize a floating bearing of a plug connector in a technically simple way, in particular in combination with a known spatial starting position in the non-plugged state.

A further object of the present invention is that of providing a battery assembly having a plug connector assembly which makes it possible to realize a floating bearing of a plug connector in a technically simple way, in particular in combination with a known spatial starting position in the non-plugged state.

The object is achieved for the plug connector assembly by the features described in claim 1. In respect of the battery assembly, the object is achieved by the features of claim 15.

The dependent claims and the features described hereinafter relate to advantageous embodiments and variants of the invention.

A plug connector assembly is provided, having an electrical plug connector, which is electrically and mechanically connectable along a plug-in direction, which will be referred to hereinafter also as a “first degree of freedom of translation”, to a corresponding mating plug connector.

The plug connector assembly according to the invention can be used particularly advantageously within a vehicle, in particular a road vehicle. Possible fields of use are, in particular, E-mobility (for example electrically operated two-wheelers), and very particularly electrical plug connector assemblies in battery-receiving containers for batteries or accumulators of the vehicles. The plug connector assembly according to the invention, however, is in principle suitable for any applications within the entire field of electrical engineering and is not to be understood as limited to the use in automotive engineering.

The electrical plug connector preferably has a plug connector housing with a connection portion (the “interface”), facing the mating plug connector, for connection to a corresponding connection portion of the electrical mating plug connector.

The electrical plug connector can have one electrical contact element or a plurality of electrical contact elements which are connectable to corresponding mating contact elements of the mating plug connector. The contact elements are preferably received in the plug connector housing and protrude into the connection portion of the plug connector housing. The contact elements can be socket contacts, pin contacts, or other contact types. The use of sprung contacts (for example spring contact pins) can also be provided.

According to the invention, the plug connector assembly has a housing component and at least one elastic element, which connects the plug connector (in particular the plug connector housing of the plug connector) indirectly or directly to the housing component.

The plug connector can be formed in particular as a cable plug connector and can have a cable outlet for an electrical cable or an electrical line or for a plurality of electrical cables or electrical lines, for example on the side facing away from the connection portion, wherein the contact elements of the plug connector are connected (for example crimped) to corresponding electrical conductors of the electrical cable. However, it can also be provided, for example, that the plug connector is formed as a printed circuit board plug connector, wherein the contact elements of the plug connector in this case are preferably connected (for example soldered) directly to conductor tracks of an electrical printed circuit board.

The plug connector can be formed as a non-angled, straight plug connector or as an angled plug connector. This is not necessarily relevant within the scope of the invention.

The housing component is preferably not the plug connector housing or not a housing part of the plug connector. The housing component is preferably formed from a plastic, but in principle can be formed from any material, for example also from a metal.

According to the invention the elastic element is designed and arranged to allow or to assist a movement of the plug connector relative to the housing component along the first degree of freedom of translation and/or along a second degree of freedom of translation and/or along a third degree of freedom of translation.

The three degrees of freedom of translation are each oriented orthogonally to one another.

On account of the mechanical assistance by the elastic element the movement between plug connector and housing component can be guided on the one hand and in addition damped in a targeted manner. For example, vibrations can be attenuated or fully absorbed.

The elastic element preferably acts indirectly or directly on the side of the plug connector or plug connector housing facing away from the mating plug connector.

The elastic element is preferably formed from a metal (in particular from a metal wire), but in principle can be formed from any material, for example also from a plastic (in particular from an elastomer).

According to the invention the plug connector assembly has at least one floating bearing assembly, which is designed and arranged to delimit the movability of the plug connector along at least one of the degrees of freedom of translation. The bearing assembly for this purpose has a bearing recess and a bearing elevation receivable in the bearing recess.

A movement delimitation or rough guidance and/or mounting between plug connector and housing component can thus be provided. The plug connector, the housing component and/or the elastic element can be guided within predefined limits, wherein a compensation movement is possible within the defined limits.

It should be noted at this juncture that the plug connector or the elastic element can also be guided exactly in one degree of freedom or in a plurality of degrees of freedom, so that no compensation movement is possible in these degrees of freedom.

The freedom of movement along the respective degrees of freedom of translation can be, for example, up to 10 mm or more, in particular approximately 5 mm, 2.5 mm or 1.5 mm.

According to a development of the invention the elastic element is arranged between the plug connector and the housing component in such a way that a primary elastic travel of the elastic element runs substantially (preferably exactly) along the plug-in direction or along the first degree of freedom of translation.

The primary elastic travel (sometimes also referred to hereinafter merely as “elastic travel” car “primary travel” for simplification) is in particular the intended direction of actuation of the elastic element, along which the elasticity of the elastic element develops its principal, primary effect—in the case of a spring, for example, the so-called spring travel. It is emphasized that an elastic element can often also be movable or act elastically to a certain extent in further directions or degrees of freedom. A spring is, for example, generally tiltable transversely to the spring travel and is then able to stand up straight again. These degrees of freedom, which do not correspond to the intended main direction of action of the elastic element, are not to be understood as “primary elastic travel” in the context of this description.

Precisely one elastic element can be provided. In principle, however, a plurality of elastic elements can also be provided (for example two, three or four or even more elastic elements), preferably in parallel arrangement or parallel orientation of the particular primary elastic travel (side by side and/or one behind the other).

Insofar as a plurality of elastic elements are provided, all elastic elements functionally involved (in any way) in the mechanical connection between the plug connector and the housing component are preferably arranged such that their respective primary elastic travels run substantially (preferably exactly) along the plug-in direction or along the first degree of freedom of translation. Preferably, no elastic elements of which the respective primary elastic travels are oriented transversely or orthogonally to one another are provided.

The elastic element is preferably designed and arranged to exert a compressive force on the plug connector in the direction of the mating plug connector. However, it can just as equally be provided that the elastic element is designed and arranged to exert a tensile force on the plug connector in the direction of the mating plug connector. Combinations of pushing and pulling elastic elements are also possible. The invention, for easier understanding, will be described hereinafter substantially by way of a compression spring or a pushing elastic element. However, this is not to be understood as limiting.

In a development of the invention it can be provided that the elastic element is movable along the second degree of freedom of translation and/or along the third degree of freedom of translation. All elastic elements involved (in any way) in the mechanical connection between the plug connector and the housing component are preferably movable along the second degree of freedom of translation and/or along the third degree of freedom of translation.

The proposed plug connector assembly can allow a tolerance compensation in a plurality of spatial directions, preferably in all degrees of freedom of translation and/or in all degrees of freedom of rotation.

According to a development of the invention it can be provided that the at least one bearing recess is formed in the housing component. In this case, the bearing elevation is preferably rigidly connected to the plug connector—directly or indirectly (for example via the extension element yet to be mentioned hereinafter).

The bearing recess can be, in particular, a slot oriented along the first degree of freedom of translation (the longer cross-sectional extent of the slot thus runs along the first degree of freedom of translation or in the plug-in direction), however, a conventional bore or another recess can be provided as appropriate. The bearing recess is preferably continuous, but can also be embodied as a blind hole as appropriate.

The bearing recess can additionally also be a tapering recess (for example a conical or pyramidal bearing recess), in particular a tapering recess of which the tip is oriented in the direction of the mating plug connector. The tapering recess thus tapers preferably along the first degree of freedom of translation (but possibly also transversely to the first degree of freedom of translation, for example along the second or third degree of freedom of translation). The tapering bearing recess can be formed in particular on or in a face of the housing component oriented at least substantially orthogonally to the first degree of freedom of translation.

In an embodiment of the invention it can be provided in particular that the bearing elevation rises in one piece from the plug connector housing and/or from the extension element or is fastened as a separate component on the plug connector housing and/or on the extension element.

The bearing elevation can be received in the bearing recess and therefore mounted and/or guided in the bearing recess.

The bearing elevation can be, in particular, a guide peg, a guide pin or a guide rib.

The bearing elevation can additionally also be a tapering elevation (for example a conical or pyramidal bearing elevation), in particular a tapering elevation of which the tip is oriented in the direction of the mating plug connector. The tapering elevation thus tapers preferably along the first degree of freedom of translation (but possibly also transversely to the first degree of freedom of translation, for example along the second or third degree of freedom of translation). The tapering bearing elevation can be formed in particular on a face of the plug connector and/or of the extension element oriented at least substantially orthogonally to the first degree of freedom of translation.

In particular the two combinations of tapering elevation and tapering recess and also pin and slot to form the floating bearing assembly have proven to be particularly suitable

A plurality of bearing assemblies can also be provided (for example two, three; four or even more bearing assemblies), in particular side by side one behind the other (preferably in parallel orientation), in relation to the first degree of freedom of translation or the plug-in direction. If a plurality of bearing assemblies are used, it can also be provided that a first bearing assembly is arranged on a first side of the housing component and a second bearing assembly is arranged on a second side of the housing component oriented at an angle (for example orthogonally) to the first side of the housing component. In this way, a floating corner positioning of the plug connector can be made possible.

Mixtures of various variants of bearing assemblies can also be provided (for example a first bearing assembly formed from a pin and a slot and a second bearing assembly formed from a tapering elevation and a tapering recess).

The bearing elevation preferably has a round cross-sectional profile. However, any cross-sectional profiles can be provided, for example also angular profiles, elliptical or other polygonal cross-sectional profiles. The cross-sectional geometry of the bearing recess can be adapted accordingly to the bearing elevation, if necessary.

In a development of the invention it can be provided that a first cross-sectional extent of the bearing recess along the first degree of freedom of translation is greater than a corresponding first cross-sectional extent of the bearing elevation. Alternatively or additionally, it can be provided that a second cross-sectional extent of the bearing recess along the second degree of freedom of translation is greater than a corresponding second cross-sectional extent of the bearing elevation.

For example, example, it can be provided that the bearing recess has a defined mechanical play or a defined freedom of movement relative to the bearing elevation in the direction of the first degree of freedom of translation and/or along the second degree of freedom of translation and/or along the third degree of freedom of translation.

As already mentioned above, the combination of a slot and a guide pin in particular has proven to be particularly suitable. In this way, a bearing with mechanical play along the first degree of freedom of translation can be provided by simple structural means if the slot is oriented lengthwise (that, is to say with its larger cross-sectional extent) along the first degree of freedom of translation. Since the slot is additionally wider than the guide pin (or another bearing elevation), a mechanical play in a degree of freedom of translation orthogonal to the first degree of freedom of translation can also be possible optionally.

A bearing or rough guidance with an oversized, conventional bore or another type of bearing recess can also be realized similarly.

As already mentioned, a play-free guidance can also be provided in at least one degree of freedom, that is to say for example in that the width of the slot corresponds approximately or exactly to the diameter of the guide pin, so that the guide pin is movable only lengthwise along the slot (and possibly in the depth).

In a development of the invention it can be provided that the bearing elevation extends fully through the bearing recess. The bearing elevation in this case is preferably held captively on the exiting side by at least one fastening element, in particular connected captively to the housing component.

The fastening element can be, for example, a screw element, in particular a flange screw. The screw element can be screwed by its shank in the bearing elevation and can support itself by the screw head and/or a washer on the housing component. However, the fastening element can also be a screw nut or a fastening element with an internal thread. The screw nut can then be screwed on the bearing elevation and can support itself directly or via a washer on the housing component. In principle, any fastening element can be provided.

In particular if a plurality of fastening elements are provided, the plug connector assembly can optionally have a fastening plate, by which at least two of the fastening elements are connected. The fastening plate preferably has a number of bores or other recesses corresponding to the number of fastening elements, which bores or other recesses are arranged coaxially to or in alignment with the corresponding bearing recesses, so that the fastening elements (or the bearing elevations) run on the one hand through the housing component and on the other hand also through the fastening plate.

It can be provided to connect the plug connector assembly by means of the fastening elements and/or the fastening plate to a surrounding, separate component, such as a wall of a housing part (for example a wall of a battery-receiving container). The bearing recess in this case can preferably also be formed in the wall of the housing part or the bearing elevation can rise from this housing part.

In an embodiment of the invention it can be provided that the height or axial length of the bearing elevation (that is to say for example the axial length of a guide pin) is greater than the depth of the bearing recess, in order to allow a compensation movement of the elastic element along the third degree of freedom of translation (that is to say for example along the longitudinal extent of the guide pin, alongside captive fastening.

In a development of the invention it can be provided that the plug connector assembly has an extension element connected to the plug connector, in particular an extension element connected rigidly and directly to the plug connector (particularly the plug connector housing). The extension element can thus be fastened to the plug connector, in particular to the plug connector housing of the plug connector.

In this way, a mechanical guidance during the movement of the plug connector and/or of the elastic element along at least one degree of freedom of translation can be provided. The extension element can be guided in the manner of a guide carriage on the housing component. In particular, however, any extension or deflection of the region of action of the elastic element that increases the flexibility in respect of the design clearance for the plug connector assembly is possible by the extension element. Thus, even small pivoting movements at the end of the extension element facing away from the plug-connector-side end of the extension element can be converted into a large movement in translation at the plug-connector-side end of the extension element.

An extension element, however, is not absolutely necessary, in particular not in order to form the bearing assemblies either. For example, the guide elevations can also be formed directly in the plug connector, as already mentioned above.

The at least one elastic element is preferably connected indirectly, or directly (in particular rigidly and directly) to the extension element. For this purpose, a plug-side end or a plug-side end portion of the elastic element can be fastened to the end or end portion of the extension element facing away from the plug connector.

In an advantageous development of the invention it can be provided that a housing-side end or a housing-side end portion of the elastic element is fastened to the housing component.

The elastic element is preferably fastened to a support face of the housing component, said support face being oriented in the direction of the plug connector.

The housing component is preferably angled and has a support portion, preferably with the aforementioned support face, to which or, on which the end of the elastic element facing away from the plug connector or the end portion of the elastic element facing away from the plug connector is fastened or at least supported, and a guide portion for guiding the plug connector, the extension element and/or the elastic element. The support portion is arranged at an angle to the guide portion, preferably orthogonally thereto. The support portion and the guide portion can be formed in one piece, but possibly also in a number of pieces. A surface normal of the support portion, in particular of the support face, preferably runs parallel to the first degree of freedom of translation. The guide portion preferably runs parallel to the first degree of freedom of translation or to the, course of the elastic element.

The elastic element preferably applies to the plug connector a force component acting along the first degree of freedom of translation or in the direction of the mating plug connector, so that the plug connector in the non-plugged state assumes the “foremost” position possible.

According to a development of the invention it can be provided that the elastic element is formed as a spring, preferably as a torsion spring.

The elastic element can also be a leaf spring. In principle, however, any elastic element can be provided, for example also an elastomer.

In a development of the invention it can be provided that the plug connector assembly has at least one center of rotation, about which the plug connector (in particular jointly with the extension element and/or jointly with the elastic element) is tiltable in order to allow the movement along the second degree of freedom of translation and/or along the third degree of freedom of translation.

It has been found that a compensation movement of the plug connector along the second or third degree of freedom of translation or along both said degrees of freedom of translation can be achieved particularly advantageously by a tilting movement.

It should be noted at this juncture that, insofar as reference is made herein to a movement in translation or tilting movement (for example along one of the degrees of freedom of translation or the plug-in direction), the specific spatial direction (the “sign” of the movement or of the movement vector) along said directions/paths is irrelevant. A movement can always occur in each case in both spatial directions.

The center of rotation is preferably arranged as far away as possible from the plug connector (for example adjoining or at least adjacently to the end of the extension element facing away from the plug connector), in order to allow the greatest possible lever effect and thus also a large translation as a result of the tilting. The center of rotation can also be provided in the region of one of the two ends of the elastic element (in particular in the region of the end of the elastic element facing away from the plug connector)—this, however, is not absolutely necessary.

In an advantageous development of the invention it can be provided that the center of rotation is formed by one of the bearing assemblies. Insofar as a plurality of bearing assemblies are provided, the center of rotation is preferably formed by a bearing assembly that is closest to the support portion of the housing component.

Depending on the embodiment of the bearing assembly used as center of rotation, a uniaxial center of rotation, a biaxial center of rotation or a triaxial center of rotation can be provided. A uniaxial center of rotation can be provided for example by a bore with guide pin guided through with an accurate fit, so that the guide pin can merely rotate about its longitudinal axis. A biaxial center of rotation can be provided for example by a slot with a guide pin guided through with an accurate fit in respect of the cross section, so that the guide pin can tilt in the direction of the longer transverse extent of the slot and can rotate in the slot about its longitudinal axis. A triaxial center of rotation can be provided for example by a slot with oversized cross section in relation to a guide pin guided through the slot, so that the guide pin can tilt in the slot in both transverse extents and can rotate in the slot about its longitudinal axis.

It should be noted at this juncture that a center of rotation is indeed advantageous, but not absolutely necessary, in order to allow a movement of the plug connector along a degree of freedom of translation. A conversion of a tilting movement at one end (for example of the extension element) into a translation movement at another end (for example of the extension element) is not absolutely necessary, for example because a pure movement in translation (at both ends) can also be provided.

In a development of the invention it can be provided that the elastic element applies an elastic restoring force (in particular spring force) to the plug connector in order to bring the plug connector in a non-plugged state into a defined spatial starting arrangement.

In this way it is possible on the one hand to use the elastic force (for example spring force) of the elastic element to guide and to stabilize the compensation movements and on the other hand to bring the plug connector into a defined (parked position), so that a plugging process with the mating plug connector is simplified. In particular, a “blind” plugging process can thus be made possible or at least assisted, so that an optional catch range or catch funnel of the plug connector and/or mating plug connector can be made smaller.

In the proposed way, an independent positioning of a plug connector mounted floatingly in the plugged state can thus be made possible.

In an advantageous development of the invention it can be provided that the plug connector assembly has at least a first positioning assembly in order to bring the plug connector in its non-plugged state into a defined, known starting arrangement (position and/or orientation).

The first positioning assembly can preferably be formed as part of at least one of the bearing assemblies. For example, at least one of the bearing recesses can have a cross-sectionally reduced portion at the front end facing the plug connector. In particular, it can be provided that the cross section of the bearing recess (for example of a slot) reduces in the direction of this front end, preferably reduces continuously. In this way, the bearing elevation (for example a guide pin) can be pushed on account of the elastic restoring force into the cross-sectionally reduced portion and in this way can be positioned and/or centered.

The first positioning assembly, however, can in principle also be an assembly which is separate from the bearing assembly and which has on the one hand a positioning receptacle or positioning guide and on the other hand a corresponding positioning elevation.

In particular a combination of a positioning elevation or bearing elevation with primarily round cross-section and of a corresponding positioning receptacle or bearing recess with likewise a primarily round cross-section, at least in the cross-sectionally reduced portion, is suitable for the proposed positioning. In principle, however, other geometries are also possible.

In an advantageous development of the invention it can be provided that the plug connector and the housing component form a second positioning assembly from a first support element the one hand and a second support element for the first support element on the other hand, wherein the second support element is displaced along the first degree of freedom of translation relative to the first support element—or vice versa—on account of the elastic restoring force acting on the plug connector in order to reach a defined supported position of the plug connector relative to the housing component.

The first support element and/or the second support element preferably have a ramp-shaped portion in order to facilitate the displacement into the supported position.

The first support element can be arranged (in one piece or as a separate component) for example as an elevation (for example as a guide rib) on a side of the extension element facing the housing component, wherein the second support element can be arranged on the guide portion (in one piece or as a separate component)—or vice versa. The second support element can be formed in particular as a support face.

A plurality of second positioning assemblies can be provided (side by side or one behind the other), for example two, three, four, five or even more second positioning assemblies.

In particular, the combinations mentioned below of bearing assemblies, centers of rotation and first positioning assemblies can be advantageous, very particularly (but not exclusively), in combination respectively with an extension element, a fastening plate and two second positioning assemblies arranged parallel to one another, wherein the following bearing assemblies are preferably formed as slot-and-guide pin combinations, with orientation of the slots with their longer transverse extent along the first degree of freedom of translation:
exactly two bearing assemblies arranged one behind the other along the first degree of freedom of translation, wherein a front, first bearing assembly approached towards the plug connector simultaneously forms a first positioning assembly with a plug-side, conical end of the slot, wherein the first bearing assembly provides a movement clearance for the guide pin along the smaller transverse extent of the slot, and wherein a rear, second bearing assembly distanced further from the plug connector forms an accurately fitting guide of the guide pin in the smaller transverse extent of the slot;
a single bearing assembly which is approached as closely as possible to the plug connector and simultaneously forms a first positioning assembly with a plug-side, conical end of the slot, wherein said bearing assembly provides a movement clearance for the guide pin along the smaller transverse extent of the slot;
exactly two bearing assemblies arranged one behind the other along the first degree of freedom of translation, wherein both bearing assemblies simultaneously form a first positioning assembly with a plug-side, conical end of the slot, and wherein the bearing assemblies each provide a movement clearance for the guide pin along the smaller transverse extent of the slot;
exactly two bearing assemblies, which are arranged on different sides of the housing component, in order to provide a corner connection, and which each simultaneously form a first positioning assembly with a plug-side, conical end of the slot and in each case provide a movement clearance for the guide pin along the smaller transverse extent of the slot;
exactly two bearing assemblies arranged side by side parallel to the first degree of freedom of translation, but at a distance from one another, and a further bearing ace assembly positioned behind the two front bearing assemblies along the first degree of freedom of translation or in the plug-in direction, preferably centrally between the two front bearing assemblies, wherein all bearing assemblies simultaneously form a first positioning assembly with a plug-side, conical end of the slot, and wherein all bearing assemblies each provide a movement clearance for the guide pin along the smaller transverse extent of the slot.

In an advantageous development of the invention it can be provided that the housing component is a wall part of a battery-receiving container or that the housing component is fastenable to a wall part of a battery-receiving container.

The plug connector can thus be fastened floatingly to the wall part of the battery-receiving container. In principle, however, the invention is suitable for any applications for floating fastening of a plug connector.

The invention also relates to a battery assembly having a plug connector assembly according to the descriptions above and below and an electrical energy store comprising the mating plug connector.

The electrical energy store can be, in particular, an electrical battery, i.e. both a non-rechargeable battery and a rechargeable battery (accumulator). The battery can optionally have only a single battery cell or accumulator cell, however, the battery preferably comprises a plurality of battery or accumulator cells, which are connected to one another in a parallel and/or series circuit and preferably deliver a common output voltage. In principle, however, the electrical energy store can be any energy store for electrical energy—and thus also an energy store that is not or not exclusively constructed electrochemically, that is to say for example a capacitor.

In this sense, the designations “battery assembly” and “battery-receiving container” are not understood as limiting to the specific use with a battery.

The battery assembly can preferably be part of a vehicle. In particular, vehicle batteries of an electric vehicle can thus be mounted in the battery-receiving container of said vehicle.

A plurality of batteries can also be provided, which are received in a common battery-receiving container. Correspondingly, a plurality of plug connector assemblies can also be provided, in particular one plug connector assembly per battery.

The mating plug connector can be a plug connector of the energy store, in particular in order to draw electrical energy from the energy store, to feed electrical energy to the energy store and/or to establish a data connection to the energy store (for example a communications link to a battery management system). The mating plug connector can be, for example, a so-called pin connector (i.e. a socket having exactly one contact pin or a plurality of contact pins arranged parallel to one another), which is fastened to an outer housing of the energy store. The plug connector can then be, in particular, a corresponding coupler in order to connect the energy store to a data and/or supply cable of the vehicle, for example in order to supply electrical energy to a drive unit.

Mechanical loads on the plug connection in the closed state can be reduced by means of the plug connector assembly, even if the energy store is not fastened in the battery-receiving container or is not fastened comprehensively therein. By way of the proposed plug connector assembly, it is possible for the plug system, in the plugged-in state together with energy stores in the battery-receiving container, to move in a compensatory manner, even if mechanical forces (for example by potholes, cornering or vibrations) occur during operation (for example during a journey of a vehicle).

A technically simple, economical and extremely robust embodiment of a “floating” fastening of the plug connection can be provided in the proposed manner. This is already possible with little effort, in particular with only few elastic elements, preferably with only a single elastic element, alongside simple assembly.

The invention is therefore particularly suitable if the energy store is movable in the battery-receiving container in at least one degree of freedom—at least within defined limits. The energy store can, however, be fixed preferably at least along the first degree of freedom of translation, for example by a battery-receiving container cover which presses the energy store in the direction of the elastic element and thus holds the elastic element in a certain elastic tension, as long as the plug connection and the battery-receiving container cover are closed.

Features described in conjunction with one of the subjects of the invention, namely given by the plug connector assembly according to the invention and the battery assembly, can also be advantageously implemented for the other subjects of the invention. Likewise, advantages mentioned in conjunction with one of the subjects of the invention can also be understood as relating to the other subjects of the invention.

It should also be noted that terms such as “comprising”, “having” or “with” do not exclude other features or steps, Furthermore, terms such as “a” or “the” that indicate a singular number of steps or features do not exclude a plurality of features or steps—and vice versa.

However, in a purist embodiment of the invention, it can also be provided that the features introduced in the invention by the terms “comprising”, “having” or “with” are enumerated exhaustively. Accordingly, one or more enumerations of features may be considered complete within the scope of the invention, for example each considered for each claim. For example, the invention may consist solely of the features described in claim 1.

It should be mentioned that designations such as “first” or “second” etc. are used primarily for reasons of distinguishability of respective device or method features and are not necessarily intended to indicate that features are mutually dependent or interrelated.

Furthermore, it should be emphasized that the values and parameters described herein include deviations or fluctuations of ±10% or fess, preferably ±5% or less, further preferably ±1% or less, and very particularly preferably ±0.1% or less of the designated value or parameter, provided that these deviations are not excluded in the implementation of the invention in practice. The specification of ranges by initial and final values also includes all those values and fractions which are included by the designated range, in particular the initial and final values and a corresponding middle value.

The invention also relates within the scope of the overall inventive concept to a self-positioning plug connector assembly independent of claim 1, having an electrical plug connector, which is electrically and mechanically connectable along a first degree of freedom of translation (or a “plug-in direction”) to a corresponding mating plug connector, a housing component and at least one elastic element, which connected the plug connector indirectly or directly to the housing component, wherein the elastic element is arranged between the plug connector and the housing component in such a way that a primary elastic travel of the elastic element runs substantially along the first degree of freedom of translation, wherein the elastic element applies an elastic restoring force to the plug connector in order to bring the plug connector in a non-plugged state into a defined spatial starting position. The further features of claim 1 and of the dependent claims, and the features described in the present description relate to advantageous embodiments and variants of this self-positioning plug connector assembly, and the applicant reserves the right to claim the plug connector assembly described in this paragraph separately from the plug connector assembly described in Claim 1, optionally in combination with the above-mentioned embodiments and variants.

Exemplary embodiments of the invention are described in greater detail below with reference to the drawings.

The figures each show preferred exemplary embodiments in which individual features of the present invention are shown in combination with one another. Features of one exemplary embodiment can also be implemented separately from the other features of the same exemplary embodiment and can accordingly be readily combined by a person skilled in the art to form further useful combinations and sub-combinations with features of other exemplary embodiments.

In the figures, functionally like elements are provided with the same reference signs.

In the figures:

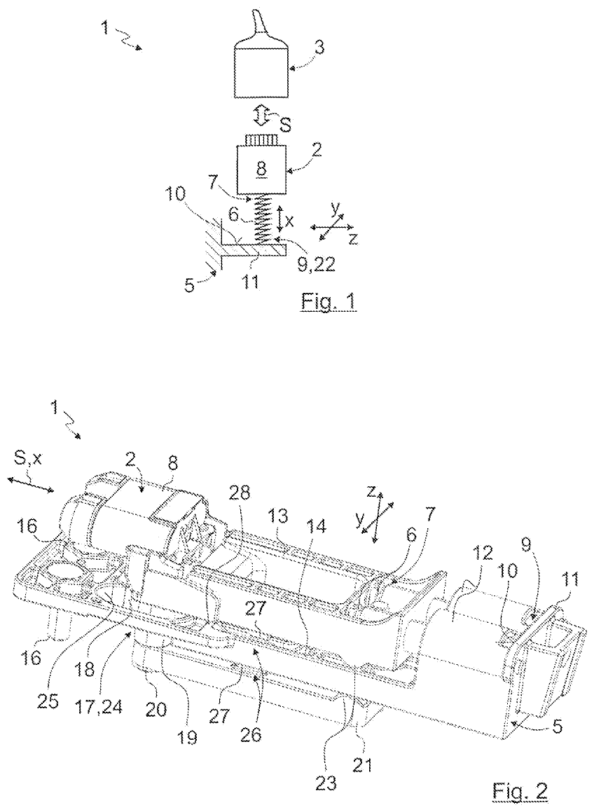

FIG. 1 schematically shows a plug connector assembly according to a minimalistic, first exemplary embodiment of the invention;

FIG. 2 schematically shows a perspective view of a plug connector assembly according to a second exemplary embodiment of the invention;

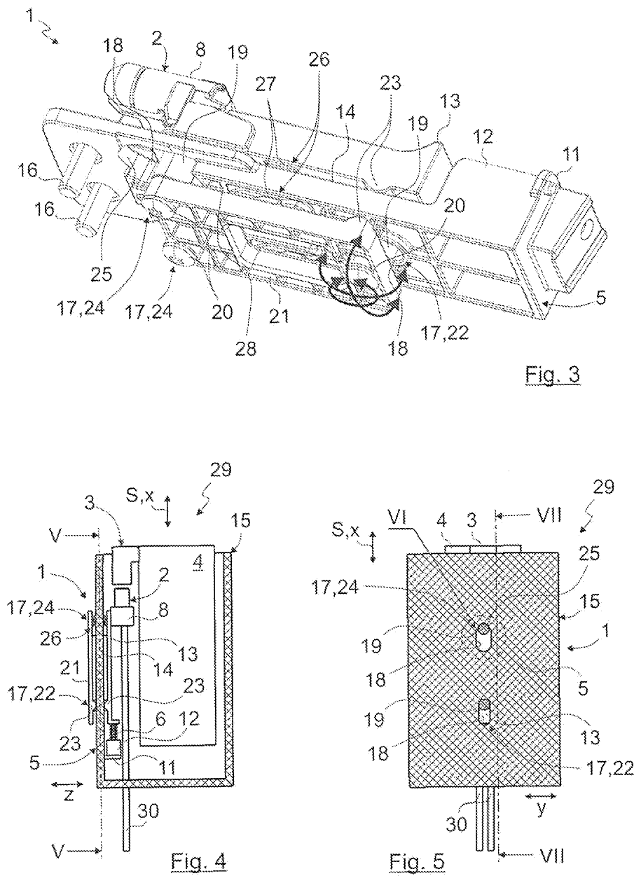

FIG. 3 schematically shows a further perspective view of the plug connector assembly of FIG. 2;

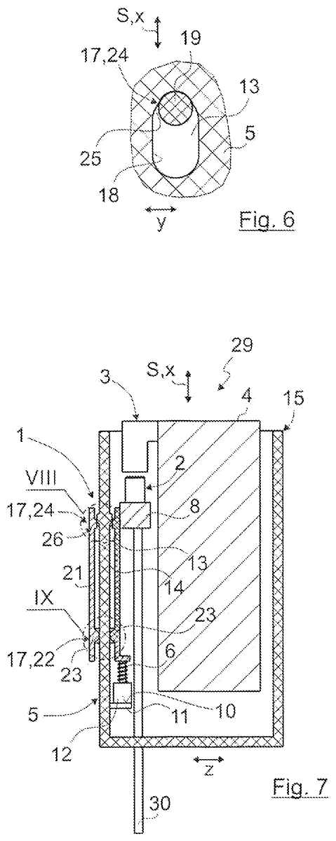

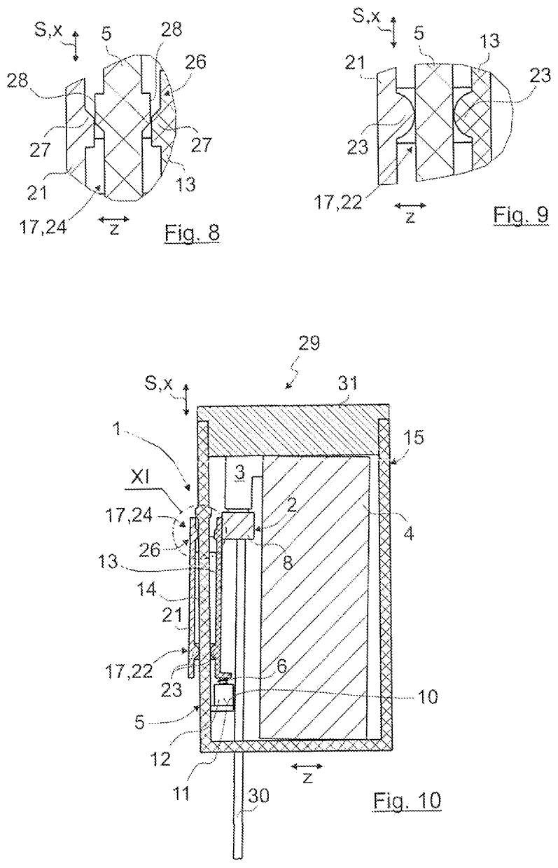

FIG. 4 schematically shows a battery assembly according to the invention with a plug connector assembly according to a third exemplary embodiment of the invention, in a lateral sectional illustration in a non-plugged state;

FIG. 5 schematically shows a battery assembly of FIG. 4 in a sectional illustration along the line of section V-V shown in FIG. 4;

FIG. 6 schematically shows the detail VI from FIG. 5 in an enlarged illustration;

FIG. 7 schematically shows the battery assembly of FIG. 4 in a sectional illustration along the line of section VII-VII shown in FIG. 5;

FIG. 8 schematically shows the detail VIII from FIG. 7 in an enlarged illustration;

FIG. 9 schematically shows the detail IX from FIG. 7 in an enlarged illustration;

FIG. 10 schematically shows the battery assembly of FIG. 4 in a plugged state of the plug connection;

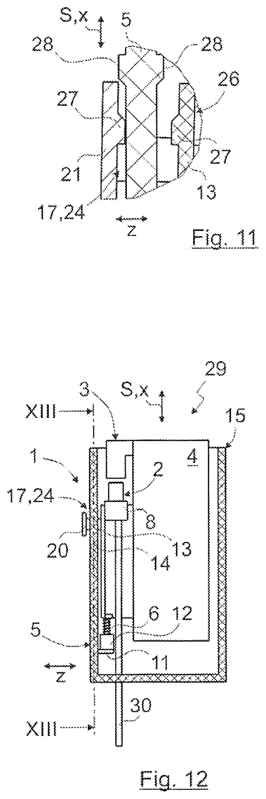

FIG. 11 schematically shows the detail XI from FIG. 10 in an enlarged illustration;

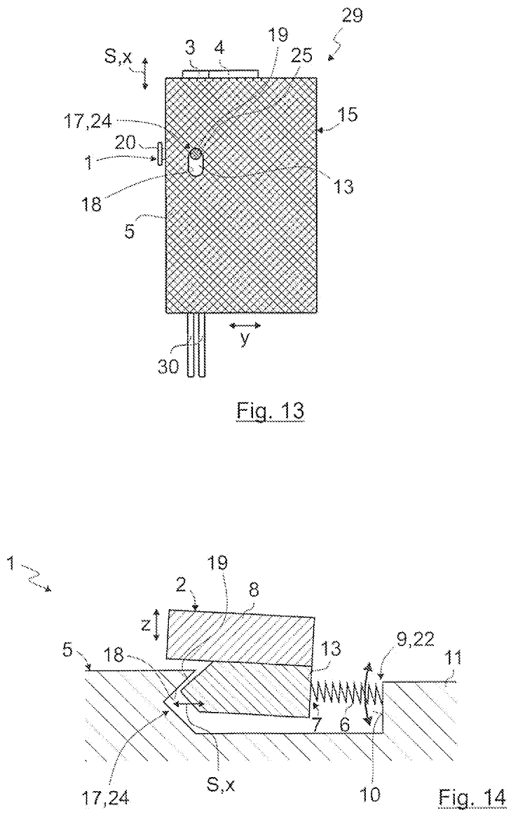

FIG. 12 schematically shows a battery assembly according to the invention with a plug connector assembly according to a fourth exemplary embodiment of the invention in a lateral sectional illustration in a non-plugged state;

FIG. 13 schematically shows the battery assembly of FIG. 12 in a sectional illustration along the line of section XIII-XIII shown in FIGS. 12; and

FIG. 14 schematically snows a plug connector assembly according to a further exemplary embodiment of the invention.

FIG. 1 shows a heavily schematized, minimalistic exemplary embodiment of the present invention. Shown is a plug connector assembly 1 which has an electrical plug connector 2 which is electrically and mechanically connectable along a plug-in direction S to a corresponding mating plug connector 3. The plug-in direction S runs along a first degree of freedom of translation x.

The invention is, in principle, suitable for use with any plug connectors 2 and mating plug connectors 2, and therefore the following exemplary embodiments in this regard are not to be understood as limiting. The invention is very particularly suitable, however, for use with plug connectors 2 which are connectable as couplers and for connection to a mating plug connector 3 (in particular with a pin connector) of an electrical energy store 4 (cf. for example FIG. 4),

The plug connector assembly 1 has a housing component 5 and an elastic element 6, which connects the plug connector 2 indirectly or directly to the housing component 5. The elastic element 6 is arranged between the plug connector 2 and the housing component 5 in such a way that the primary elastic travel, of the elastic element 6 runs substantially along the first degree of freedom of translation x or in the plug-in direction S. In this regard, a plurality of elastic elements 6 are provided, and these are preferably all oriented along the first degree of freedom of translation x or parallel to one another. The at least one elastic element 6 allows a movement of the plug connector 2 along the first degree of freedom of translation x or transversely to the plug-in direction S along the plug-in direction S and/or along one of the two degrees of freedom of translation y, z yet to be described hereinafter.

In FIG. 1 the elastic element 6 is shown heavily schematized as a torsion spring or leaf spring and connects the housing component 5 and plug connector 2 directly. For this purpose, the elastic element 6 is fastened by a plug-side end portion 7 to a plug connector housing 8 of the plug connector 2 on the one hand and by a housing-side end portion 9 to a support face 10 of a support portion 11 of the housing component 5 on the other hand.

In the illustrated manner, the elastic element 6 is movable in its arrangement between the plug connector 2 and the housing component 5 along a second degree of freedom of translation y and/or along a third degree of freedom of translation z, in each ease orthogonally to the first degree of freedom of translation x. In FIG. 1, a guide for this, along the second degree of freedom of translation y and the third degree of freedom of translation z, is dispensed with fully. The elastic element 6 therefore allows a tilting movement to be performed, which causes a translation of the plug connector 2 along one of said degrees of freedom of translation y, z. A compensation in the plug-in direction S can additionally occur advantageously along the first degree of freedom of translation x.

As already mentioned, the exemplary embodiment shown in FIG. 1 is to be understood as minimalistic and heavily schematized. It is generally advantageous to provide at least a certain rough guidance also along the second degree of freedom of translation y and/or along the third degree of freedom of translation z in order to obtain a more stable arrangement. In particular, the exemplary embodiments shown in the following FIGS. 2 to 13 are optimized in this regard.

A second exemplary embodiment of the invention is shown in perspective with reference to FIGS. 2 to 3. The corresponding mating plug connector 3 is not shown in FIGS. 2 and 3.

Again, the plug connector assembly 1 has an electrical plug connector 2 with a plug connector housing 8. Two elastic elements 6, which for example are formed again as torsion springs, run between the plug connector 2 and the housing component 5. The elastic elements 6 are oriented parallel to one another and in each case along the first degree of freedom of translation x. The first elements are partially mounted or roughly guided along their longitudinal axis and are supported by their respective housing-side end portions 9 on a common support portion 11 of the housing component 5. In the region, of the support portion 11, the elastic elements 6 are guided with radial play by respective guide sleeves 12.

In the exemplary embodiments of FIGS. 2 to 14 the elastic elements 6 connect the plug connector 2 and the housing component 5 indirectly with use of an extension element 13 which is fastened to the plug connector 2 and to which the plug-side end portion 7 of the elastic elements 6 is fastened.

Also in the exemplary embodiments of FIGS. 2 to 14, the housing component 5 in each case has a support portion 11 with a support face 10. Transversely, in particular orthogonally, to the support face 10, there runs a guide portion 14. The guide portion 14 runs parallel to the first degree of freedom of translation x and allows the extension element 13 to be guided or at least supported.

The housing component 5 can be a wall part of a battery-receiving container 15 (cf. FIGS. 4 to 13) or connectable to a wall part of the battery-receiving container 15, for example via the fastening means 16 shown in FIGS. 2 and 3.

The plug connector assembly 1 shown in FIGS. 2 and 3 has three bearing assemblies 17 for delimiting the movability of the plug connector 2 along the first degree of freedom of translation x and additionally for delimiting the movability of the elastic elements 6 along the second degree of freedom of translation y and along the third degree of freedom of translation z. The bearing assemblies 17 each have a bearing recess 18, embodied as a slot, oriented along the first degree of freedom of translation x, and respective bearing elevations 19 in the form of guide pins, which are received and mounted in the bearing recess 18 or in the slot. The bearing elevations 19 or guide pins are rigidly connected via the extension element 13 to the plug connector housing 8. Here, a defined mechanical play is provided between each of the bearing recesses 18 and bearing elevations in the direction of the first degree of freedom of translation x by the elongate geometry of the slot 18, and along the second degree of freedom of translation y on account of the shown radial oversize of the slot 18 relative to the bearing elevation 19 or the guide pin.

The bearing elevations 19 or guide pins extend fully through their respective bearing recesses 18 or through their respective slots and protrude on the other side from the housing component 5. The bearing elevations 19 or guide pins are connected to a common fastening plate 21 via fastening elements 20 (flange screws are shown by way of example), whereby a captive arrangement can be provided. The height of the bearing elevations 19 or the axial length of the guide pins is dimensioned such that a defined axial play is provided along the third degree of freedom of translation with the passage through the corresponding bearing recess 18.

Due to the mechanical play provided by the bearing assemblies 17, the plug connector 2 makes it possible to perform a compensation movement and for example to follow the movement of an electrical device (for example the energy store 4 indicated in the following figures) connected to the plug connector via a mating plug connector 3.

This compensation movement can be made possible on the one hand along the first degree of freedom of translation x (that is to say in the present case in the longitudinal direction of the slots 18) and in the two further degrees of freedom of translation y, z on account of the possibility of the tilting of the extension element 13 or the elastic elements 6. In order for said tilting to be made possible advantageously, at least one center of rotation 22 (cf. FIG. 3) can be provided, about which the plug connector 2 is tiltable in order to allow the movement along the second degree of freedom of translation y and/or along the third degree of freedom of translation z. The rotation center 22 can be formed in particular by the “rearmost” bearing assembly 17, which is closest to the support portion 11. The center of rotation 22 is preferably arranged adjoining, to the greatest possible extent, the end of the extension element 7 facing away from the plug connector 2, or at least is arranged adjacently thereto. The three degrees of freedom of tilt provided by the rear bearing assembly 17 are indicated in FIG. 3 by corresponding arrows.

For example, in respect of the third degree of freedom of translation z, suitable outwardly rounded portions 23 of the extension element 13 (but possibly also of the plug connector 2 or of the elastic element 6 itself) and/or of the optional fastening plate 21 can be provided in the region of the center of rotation 22 in order to provide a possibility for support and to mechanically stabilize the movement (cf. in particular FIG. 3 and FIG. 9).

In order to allow the plug connector 2 and the mating plug connector 3 to find each other more easily, in particular in the case of a blind plugging process, it can be provided that the elastic element 6 applies an elastic restoring force to the plug connector 2, whereby the plug connector 2 in the non-plugged state is brought into a defined spatial starting position. For this purpose, at least one first positioning assembly 24 can be provided, which in the exemplary embodiment of FIGS. 2 and 3 is formed by the two “front” bearing assemblies 17 (that is to say the bearing assemblies 17 which are closest to the plug connector 2). Each front guide pin 19 is pushed into a cross-sectionally reduced portion 25 of the bearing recess 18 by the restoring force of the elastic elements 6 (cf. also FIG. 6). This can be achieved in principle via an arbitrary first positioning assembly—in particular with use of a plurality of bearing assemblies 17 arranged one behind the other along the first degree of freedom of translation x, the first positioning assembly 24 does not necessarily also have to be formed by the front bearing assembly 17.

In addition, it should also be mentioned at this juncture by way of precaution that, alternatively or additionally to a “pushing” elastic element 6, a “pulling” elastic element 6 can also be provided in order to apply a restoring force to the plug connector 6 in the plug-in direction S or in the direction of the mating plug connector 3.

In addition, a second positioning assembly 26 formed from a ramp-shaped first support element 27 on the one hand and a second support element 28 for the first support element 27 on the other hand can be provided in order to delimit or to stabilize the movement of the plug connector 2 along the third degree of freedom of translation z and in order to provide an automatic positioning function for the third degree of freedom of translation if the plug connector 2 is in its non-plugged basic state. In the exemplary embodiments of FIGS. 2 to 13, the extension element 13 has two ramp-shaped first support elements 27 running in parallel, which correspond to second support elements 28 of the housing component 5 (along its guide portion 14). The second support elements 28 are arranged here at the end of a ramp-shaped indentation formed in the housing component 5. In the same way, a rough guidance is provided between the fastening plate 21 and the housing component 5.

In the illustrations of FIGS. 2 and 3, the elastic elements 6 are shown compressed by way of example, as would be the case in a plugged state of the plug connection. The ramp-shaped first support elements 27 in FIGS. 2 and 3 therefore are not supported on the second support element 28, and a defined play is provided for a compensation movement along the third degree of freedom of translation z. If, by contrast, on account of the elastic restoring force of the elastic elements 6 in the non-plugged state, the plug connector 2 is displaced forwards along the first degree of freedom of translation x (that is to say in the direction of the mating plug connector 3), the ramp-shaped first support element 27 is brought into its supported position on the second support element 28.

The principle can also be seen very clearly in particular by comparing FIGS. 7/8 and 10/11. FIG. 7 shows here the non-plugged, supported state (FIG. 8 shows an enlarged illustration of the second positioning assembly 26) and FIGS. 10 and 11 correspond to the plugged, compensation-enabled state.

A plug connector assembly 1 according to a third exemplary embodiment is indicated in FIGS. 4 to 9. The figures additionally also show a battery assembly 29, in which the plug connector assembly 1 can be used advantageously in order to contact an electrical energy store 4, such as a battery, via its “mating plug connector” 3 within a battery-receiving container 15. The plug connector 2 is, for example, a cable plug connector, the cables 30 or lines of which are guided out from the battery-receiving container 15. The mechanical play of the energy store 4 within the battery-receiving container 15 is shown in an exaggerated manner in FIGS. 4 to 13 for improved clarification of the principle.

The exemplary embodiments of FIGS. 4 to 14 are, in principle, similar to the variants already described, and therefore for the most part the differences between the individual exemplary embodiments will be discussed hereinafter.

FIGS. 4 to 9 show the plug connector assembly 1 in each case in a non-plugged state of the plug connection and therefore in the independently positioned, defined idle state. By contrast, the plugged state is shown in FIGS. 10 and 11, wherein the energy store 4 is shown tilted along the third degree of freedom of translation z. In this state it can be provided that the battery-receiving container 15 is closed by a battery-receiving container cover 31 (cf. FIG. 10), whereby the energy store 4 is displaced against the restoring force of the elastic element 6 and in this way is clamped in the battery-receiving container 15. The energy store 4 is additionally supported by way of this clamping.

In the shown exemplary embodiment, two bearing assemblies 17 are provided, which are arranged one behind the other along the first degree of freedom of translation x. The front bearing assembly 17 serves at the same time as first positioning assembly 24 and the rear bearing assembly 17 as center of rotation 22. A slot 18 and a guide pin 19, which is received in the slot 18, of the extension element 13 are provided in each case.

As can be seen particularly clearly with reference to FIGS. 5 and 6, the plug connector 2 in its non-plugged basic state self-positions and orients itself on account of the elastic restoring force of the elastic element 6, since the guide pin 19 is pushed forward in the bearing recess 18 or in the slot 18 along the first degree of freedom of translation x until in a tapered, cross-sectionally reduced portion 25. In this way, the plug connector 2 is positioned and/or centered by simple means along the first degree of freedom of translation x and also along the second degree of freedom of translation y.

At the same time, an automatic positioning is performed along the third degree of freedom of translation z by a second positioning assembly 26, as has already been described above (cf. FIGS. 7/8 and 10/11), Similarly to the preceding exemplary embodiment, in the state in which the plug connector 2 is pushed forward, ramp-shaped first support elements 27 of the extension element 13 and of the fastening plate 21 are brought into contact with corresponding second support elements 28 of the housing component 5, whereby the defined positioning in the third degree of freedom of translation z is achieved. If, by contrast, the plug connector 2 together with extension element 13 is displaced rearward, against the travel of the elastic element 6, on account of the plugging process, a compensation movement is possible since the ramp-shaped first support elements 27 are distanced from the second support elements 28.

A center of rotation 22 is again configured to convert a corresponding tilting movement of the elastic element 6 or e extension element 13 into a translation movement along the second degree of freedom of translation y and/or the third degree of freedom of translation z. The center of rotation 22 is realized by the rear bearing assembly 17.

FIGS. 12 and 13 show a fourth exemplary embodiment of a plug connector assembly 1 or battery assembly 29 according to the invention, wherein the plug connection is shown by way of example in its closed state, in which the compensation movements already described are possible.

FIGS. 12 and 13 are intended to clarify that a corner connection between plug connector 2 or extension element 13 and housing component 5 can also be possible with the proposed technology. For this purpose, a first bearing assembly 17 can be provided on a first side of the housing component 5 and a second bearing assembly 17 can be provided on a second side of the housing component 5 oriented orthogonally to said first side. In this case too, further bearing assemblies 17, centers of rotation 22 and/or first positioning assemblies 24 can also optionally be provided, for example offset along the first degree of freedom of translation x.

Lastly, a further advantageous variant of a bearing assembly 17 is also presented with reference to FIG. 14 and can be applied within the scope of the invention. Alternatively (or additionally) to a bearing assembly 17 formed from a slot and a guide pin, a bearing assembly 17 can also be formed by a tapering bearing recess 18, into which a tapering bearing elevation 19 can be introduced. The respective tips of the bearing elevation 19 and of the bearing recess 18 are oriented in the direction of the mating plug connector. In particular, an advantageous first positioning assembly 24 can also be provided in this way at the same time.

1. A plug connector assembly (1) comprising:
a housing component (5);
a corresponding mating plug connector (3);
an electrical plug connector (2), which is electrically and mechanically connectable along a first degree of freedom of translation (x) to the corresponding mating plug connector (3); and
at least one elastic element (6), which connects the electrical plug connector (2) indirectly or directly to the housing component (5) and which allows movement of the electrical plug connector (2) relative to the housing component (5) along the first degree of freedom of translation (x) and/or along a second degree of freedom of translation (y) and/or along a third degree of freedom of translation (z); and
at least one floating bearing assembly (17) for delimiting the movability of the electrical plug connector (2) along at least one of the degrees of freedom of translation (x, y, z), the at least one floating bearing assembly having a bearing recess (18) and a bearing elevation (19) receivable in the bearing recess (18); and wherein
the at least one elastic element (6) applies an elastic restoring force to the electrical plug connector (2) to bring the electrical plug connector (2), in an unplugged state, into a defined spatial starting position.

2. The plug connector assembly (1) as claimed in claim 1 and wherein the at least one elastic element (6), is functionally involved in the connection between the electrical plug connector (2) and the housing component (5); and
the at least one elastic element (6), is arranged between the electrical plug connector (2) and the housing component (5) in such a way that a primary elastic travel of the at least one elastic element (6) is effective substantially along the first degree of freedom of translation (x).

3. The plug connector assembly (1) as claimed in claim 1 and wherein the at least one elastic element (6) is functionally involved in the connection between the electrical plug connector (2) and the housing component (5); and
the at least one elastic component (6) is movable along the second degree of freedom of translation (y), and/or along the third degree of freedom of translation (z).

4. The plug connector assembly (1) as claimed in claim 1 and wherein the bearing recess (18) is formed in the housing component (5); and
the bearing elevation (19) is rigidly connected to the plug connector (2).

5. The plug connector assembly (1) as claimed in claim 1 and wherein a first cross-sectional extent of the bearing recess (18) along the first degree of freedom of translation (x) is greater than a corresponding first cross-sectional extent of the bearing elevation (19); and
a second cross-sectional extent of the bearing recess (18) along the second degree of freedom of translation (y) is greater than a corresponding second cross-sectional extent of the bearing elevation (19).

6. The plug connector assembly (1) as claimed in claim 1 and further comprising:
at least one fastening element (20); and
the bearing elevation (19) extends fully through the bearing recess (18) and the bearing elevation (19) is held captively on an exiting side by the at least one fastening element (20); and wherein
a height of the bearing elevation (19) is greater than a depth of the bearing recess (18) in order to allow a compensation movement of the at least one elastic element (6) along the third degree of freedom of translation (z).

7. The plug connector assembly (1) as claimed in claim 1 and further comprising:
an extension element (13), which is connected rigidly and directly to the electrical plug connector (2); and
a plug-side end portion (7) of the at least one elastic element (6) is fastened to the extension element (13).

8. The plug connector assembly (1) as claimed in claim 1 and wherein the at least one elastic element (6) is a torsion spring.

9. The plug connector assembly (1) as claimed in claim 1 and further comprising:
at least one rotation center (22), about which the electrical plug connector (2) is tiltable to allow movement along the second degree of freedom of translation (y) and/or along the third degree of freedom of translation (z).

10. The plug connector assembly (1) as claimed in claim 9 and wherein the rotation center (22) is formed by one of the at least one floating bearing assembly (17).

11. The plug connector assembly (1) as claimed in claim 11 and wherein at least one floating bearing assembly (17) is formed as a first positioning assembly (24); and wherein
the bearing recess (18) has, on a plug-side end, a cross-sectionally reduced portion (25), so that the bearing elevation (19) is pressed into the cross-sectionally reduced portion (25) on account of the elastic restoring force.

12. The plug connector assembly (1) as claimed in claim 1 and wherein the electrical plug connector (2) and the housing component (5) form a second positioning assembly (26) from a first support element (27) and a second support element (28) for the first support element (27); and wherein
the second support element (28) is displaced along the first degree of freedom of translation (x) relative to the first support element (27) by the elastic restoring force acting on the electrical plug connector (2) in order to reach a defined supported position of the electrical plug connector (2) relative to the housing component (5).

13. The plug connector assembly (1) as claimed in claim 1 and further comprising:
a battery-receiving container (15) having at least one wall; and
the housing component (5) is a wall part of a battery-receiving container (15).

14. A battery assembly (29) comprising:
a plug connector assembly (1), plug connector assembly (1) having
a housing component (5),
a corresponding mating plug connector (3),
an electrical plug connector (2), which is electrically and mechanically connectable along a first degree of freedom of translation (x) to the corresponding mating plug connector (3), and
at least one elastic element (6), which connects the electrical plug connector (2) indirectly or directly to the housing component (5) and which allows movement of the electrical plug connector (2) relative to the housing component (5) along the first degree of freedom of translation (x) and/or along a second decree of freedom of translation (y) and/or along a third degree of freedom of translation (z), and
at least one floating bearing assembly (17) for delimiting the movability of the electrical plug connector (2) along at least one of the degrees of freedom of translation (x, y, z), the at least one floating bearing assembly having a bearing recess (18) and a hearing elevation (19) receivable n the bearing recess (18), and wherein
the at least one elastic element (6) applies an elastic restoring force to the electrical plug connector (2) to bring the electrical plug connector (2), in an unplugged state, into a defined spatial starting position; and
an electrical energy store (4), which comprises the corresponding mating plug connector (3).

15. The plug connector assembly (1) as claimed in claim 4 and wherein the bearing recess (18) is formed as a slot oriented along the first degree of freedom of translation (x).

16. The plug connector assembly (1) as claimed in claim 1 and wherein a first cross-sectional extent of the bearing recess (18) along the first degree of freedom of translation (x) is greater than a corresponding first cross-sectional extent of the bearing elevation (19); or
a second cross-sectional extent of the bearing recess (18) along the second degree of freedom of translation (y) is greater than a corresponding second cross-sectional extent of the bearing elevation (19).

17. The plug connector assembly (1) as claimed in claim 1 and further comprising:
a battery-receiving container (15) having at least one wall; and
the housing component (5) is fastenable to a wall part of a battery-receiving container (15).
